(19) United States
(12) Patent Application Publication
(10) Pub. No.: US 2013/0052871 A1
(43) Pub. Date: Feb. 28, 2013

(54) METHOD AND APPARATUS OF A CHARGING CELL PHONE CASE

(71) Applicant: Andrew Eklind, Woodstock, GA (US)

(72) Inventor: Andrew Eklind, Woodstock, GA (US)

(21) Appl. No.: 13/033,847

(22) Filed: Feb. 24, 2011

(51) Int. Cl. H01R 13/66

(52) U.S. Cl. 439/620.21

(57) ABSTRACT

Charging cell-phone case comprising a case having a receiving section for receiving a cell phone, an electrical male member that mates with the female charging portion of the cell-phone, circuitry to convert the input AC power to the desired DC output, and a foldable recessed plug for mating with a AC outlet.

### TECHNICAL FIELD

The technical field generally relates to cell phone cases and more specifically to a cell phone case having charging capabilities and method thereof.

### BACKGROUND

Cell phone usage has seen an enormous and consistent growth over the last several years. By the end of year 2008, there were an estimated 4.1 billion mobile subscriptions, up from 1 billion in 2002. That represents 6 in 10 of the world's population.

A survey of wireless carriers in 2009 revealed that over 285 million Americans were mobile subscribers, about 91 percent of the total population. Those 285 million callers used 1.12 trillion minutes of talk time in the last half of 2009, up 3.4 percent of the same period in 2008. That breaks clown to an average of 6.1 billion minutes used per day. In the U.S. alone, Wireless service revenues totaled $77 billion for the last half of 2009.

To maintain the use of a cell phone, the user must periodically charge the cellular battery. This is typically performed via the use of an AC charger, wherein one end plugs into an AC wall socket and wherein the other end, separated by a length of wire, plugs into the cell phone. As such, in addition to their cell phones, cell phone users typically travel with a separate AC charger. Because of the nature of having an additional device to keep up with, many cell-phone users lose and/or break the cell phone chargers thus resulting in the costly requirement of buying additional chargers. Thus, there is an unmet need for a device that eliminates this prior deficient method/apparatus of cell-phone charging.

### SUMMARY

The present invention meets and satisfies the above-unmet need by providing a charging cell-phone case that eliminates the need for a separate charger. The present charging cell-phone case comprises a case having a receiving section for receiving a cell phone, an electrical male member that mates with the female charging portion of the cell-phone, circuitry to convert the input AC power to the desired DC output, and a foldable recessed plug for mating with a AC outlet.

### BRIEF DESCRIPTION OF THE DRAWINGS

The following detailed description of preferred embodiments is better understood when read in conjunction with the appended drawings. For the purposes of illustration, there is shown. in the drawings exemplary embodiments; however, the subject matter is not limited to the specific elements and instrumentalities disclosed.

FIG. 1A is a rear view of the preferred embodiment of the present invention;

FIG. 1B is a front partial section view of the preferred embodiment of the present invention; and

FIG. 1C is a side view of the preferred embodiment of the present invention.

### DETAILED DESCRIPTION OF ILLUSTRATIVE EMBODIMENTS

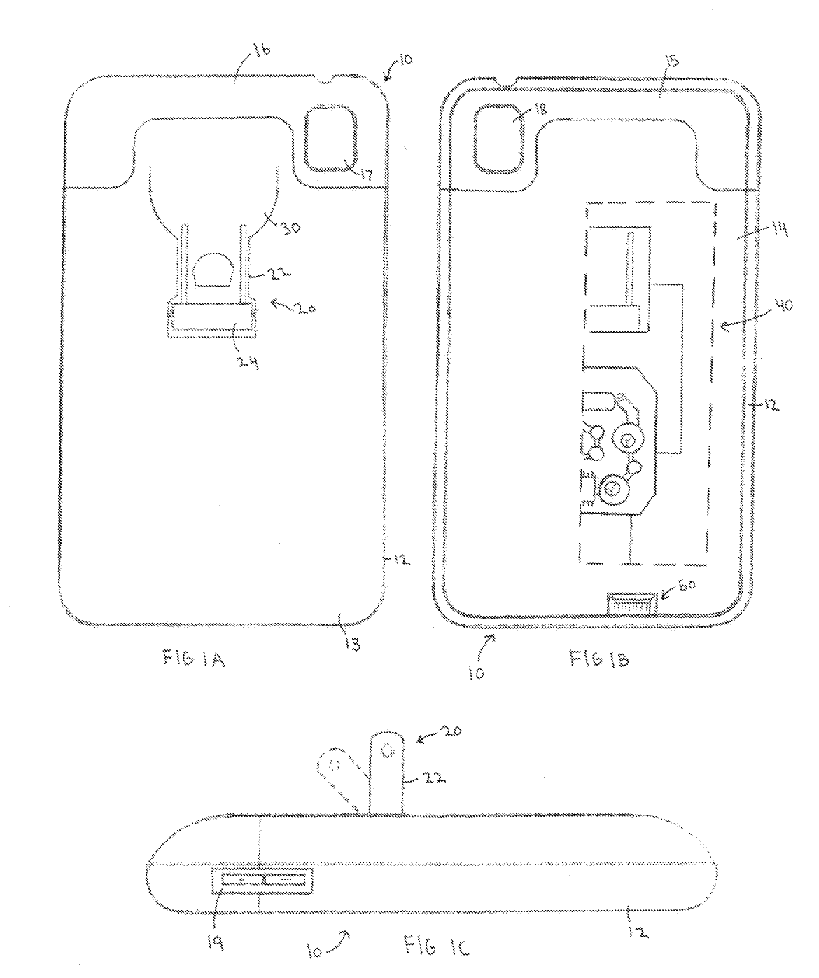

FIGS. 1A-1C illustrates one embodiment of the present invention. As shown in FIG. 1A-1C, device 10 comprises case 12, AC plug assembly 20, recess area 30, AC/DC circuitry 40 and male cell-phone plug member 50. More specifically, case 12 is preferably formed from a rigid or semi-rigid material such as from plastic or rubber or combination thereof. Although plastic and/or rubber are the preferred materials, any known available cell-phone case material or combination thereof may be utilized.

Case 12 comprises a rear portion 13, a front receiving portion 14, an upper front support portion 15, an upper rear support portion 16, a rear window 17, a front window 18, and a side window 19. Front receiving portion 14 is dimensioned to receive the desired cell phone, wherein upper front support portion 15 and upper rear support portion 16 are preferably more rigid relative to the other portions of case 12 and serve to add additional support and protection. In alternate embodiments, the size and location of support portions can vary depending on the desired level of protection of the user. Rear window 17 and front window 18 are positioned to align with the camera or other portion of the desired cell phone. Side window 19 is positioned to allow operation of the volume control or other cell-phone control feature. In alternate embodiments, the number and position of windows can be varied depending on the desired cell phone.

AC plug assembly 20, AC/DC circuitry 40 and male cell-phone plug member 50 are in electrical communication. AC/DC circuitry 40 is preferably incased within case 12 and is formed from well-known circuitry designed to convert AC power to DC power and to reduce as is necessary for the desired cell phone. With the known AC input and the desired DC output, one skilled in the art would be able to utilize any one of a multitude of known AC/DC circuits. AC plug assembly 20 comprises plug 22 and mounting member 24 wherein plug 22 is pivotably mounted to case 12 within recess area 30 via mounting member 24 such that plug 22 can be pivoted to the extended. position for use or to the recessed position when not charging. Male cell-phone plug member 50 is dimensioned to mate with and be in electrical communication with the female power plug member of the desired cell phone. As the position and size of the female power plug member of cell phones vary, it is understood, in alternate embodiments, that male cell-phone plug member 50 may be positioned on case 12 and dimensioned to mate with the known desired cell phone to be utilized.

In use, the desired cell phone is placed within case 12 wherein male cell-phone plug member 50 is received within the female power plug portion of the phone. When charging is desired, plug 22 is pivoted to the extended position and plugged into an AC outlet wherein the case including the phone are attached thereto and wherein when the desired level of charging is complete, the entire assembly is unplugged and plug 22 is pivoted back to the recessed position. In an alternate embodiment, it is contemplated that a known DC automobile cigarette lighter plug is positioned in place of or in addition to plug 22 to allow said device to be charged within an automobile.

What is claimed:

1. A cell-phone case comprising:
a body having a recessed area dimensioned to receive a cell phone;
a male plug member dimensioned to be received within and in electrical communication with the female power plug portion of a cell phone; and
a power plug for electrical communication with a power source, wherein said power plug is in electrical communication with said male plug member.

2. The cell-phone case of claim 1, wherein said power plug is a standard AC 2-prong plug.

3. The cell-phone case of claim 1, further comprising means for converting AC power to DC power.

4. The cell-phone case of claim 3, wherein said means for converting is an AC/DC adapter circuit.

5. The cell-phone case of claim 1, wherein said power plug is a standard automobile cigarette lighter plug.

6. The cell-phone case of claim 1, wherein said power plug is pivotably mounted to said body.

7. A cell-phone case comprising:
a body having a recessed area dimensioned to receive a cell phone;
a male plug member dimensioned to be received within and in electrical communication with the female power plug portion of a cell phone; and
an AC power plug for electrical communication with a power source, wherein said AC power plug is in electrical communication with said male plug member.

8. The cell-phone case of claim 7, further comprising means for converting AC power to DC power.

9. The cell-phone case of claim 8, wherein said means for converting is an AC/DC adapter circuit.

10. The cell-phone case of claim 7, wherein said power plug is pivotably mounted to said body.

11. A cell-phone case comprising:
a body having a recessed area dimensioned to receive a cell phone;
a male plug member dimensioned to be received within and in electrical communication with the female power plug portion of a cell phone;
means for converting AC power to DC power; and
an AC power plug for electrical communication with a power source, wherein said AC power plug is in electrical communication with said male plug member.

12. The cell-phone case of claim 11, wherein said means for converting is an AC/DC adapter circuit.

13. The cell-phone case of claim 11, wherein said power plug is pivotably mounted to said body.
